(19) United States
(12) Patent Application Publication
(10) Pub. No.: US 2006/0003242 A1
(43) Pub. Date: Jan. 5, 2006

(54) Method of making coating composition for producing single layered photosensitive layer by using homogenizer

(75) Inventors: Hwan-koo Lee, Suwon-si (KR); Saburo Yokota, Suwon-si (KR); Beom-jun Kim, Seongnam-si (KR); Seung-ju Kim, Suwon-si (KR); Kyung-yol Yon, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/171,278

(22) Filed: Jul. 1, 2005

(30) Foreign Application Priority Data
Jul. 1, 2004 (KR) 2004-51144

(51) Int. Cl. G03G 5/06; G03G 5/14

(52) U.S. Cl. 430/62; 430/60; 430/135; 430/133; 430/56

(57) ABSTRACT

A method of making a coating composition yields a single layered photosensitive layer including a pigment powder, which acts as a charge generating material (CGM), dispersed in a solution of a binder resin. The method includes adding the pigment powder, a hole transporting material, an electron transporting material, and the binder resin to a solvent to wet the pigment powder; and homogenizing the components while pulverizing the pigment powder.

### CROSS REFERENCE TO RELATED APPLICATIONS

This application claims the priority of Korean Patent Application No. 10-2004-0051144, filed on Jul. 1, 2004, in the Korean Intellectual Property Office, the disclosure of which is incorporated herein in its entirety by reference.

1. Field of the Invention

The present invention relates to a method of making a coating composition for producing a single layered photosensitive layer which is used to prepare a single layered electrophotographic photoreceptor, and more particularly, to an inexpensive method of making a coating composition for producing a single layered photosensitive layer, which reduces manufacturing costs of a single layered electrophotographic photoreceptor.

2. Description of the Related Art

In electrophotography used in laser printers, photocopiers, CRT printers, LED printers, liquid crystal printers, etc., an electrophotographic photoreceptor in the form of a plate, disk, sheet, belt, drum or the like includes a photosensitive layer formed on an electrically conductive substrate. In electrophotography, the electrophotographic photoreceptor is imaged by first uniformly electrostatically charging the surface of the photosensitive layer, and then exposing the charged surface to a pattern of light. The light exposure selectively dissipates the charge in the illuminated areas where light strikes the surface, thereby forming a pattern of charged and uncharged areas, referred to as a latent image. A liquid or solid toner is then provided in the vicinity of the latent image, and toner droplets or particles deposited in the vicinity of either the charged or uncharged areas create a toned image on the surface of the photosensitive layer. The resulting toned image can be transferred and fixed to a suitable ultimate or intermediate receiving surface, such as paper, thereby completing the formation of an image. After that, the residual toner is cleaned and residual charges are erased from the electrophotographic photoreceptor. Thus, the electrophotographic photoreceptor can be repeatedly used for long periods.

The electrophotographic photoreceptor includes an inorganic photoreceptor in which an inorganic material, such as selenium or amorphous silicon, is used in a photosensitive layer, and an organic photoreceptor in which an organic material is used in a photosensitive layer. It is noted that the electrophotographic photoreceptor can be easily manufactured, that a charge generating material (CGM), a charge transporting material (CTM), and a binder resin can be selected from a wide variety of respective candidate materials, and that the degree of freedom in designing the photoreceptor is broad.

Electrophotographic photoreceptors are widely categorized into two types. The first is a laminated-type having a laminated structure including a charge generating layer comprising a binder resin and a CGM, and a charge transporting layer comprising a binder resin and a CTM (mainly, a hole transporting material (HTM)). In general, the laminated-type organic photoreceptor is used in the fabrication of a negative (−) type electrophotographic photoreceptor in which the charge generating layer and the charge transporting layer are sequentially laminated on the electrically conductive substrate. The other type is a single layer type in which a binder resin, a CGM, an HTM and an electron transporting material (ETM) are dispersed in an electophotosensitive layer. In general, the single layer-type organic photoreceptor is used in the fabrication of a positive (+) type electrophotographic photoreceptor. Meanwhile, the single layer type organic photoreceptor is advantageous in that its simple layer structure increases productivity; coating defects of the photosensitive layer may be suppressed; it generates a only small amount of ozone harmful to human bodies; it can improve optical properties due to limited interface between layers; and since the ETM and the HTM are used in combination as the CTM, it can be used in the fabrication of both positive (+) type and negative (−) type electrophotographic photoreceptors.

Conventionally, when a pigment is used as the CGM, a coating composition for producing a single layer type photosensitive layer is prepared according to a two-step method including separately forming a CGM composition and a CTM composition and mixing them, as described in Korean Patent Laid-Open Publication No. 2004-0005528.

That is, a photosensitive pigment powder is pulverized very finely for use in the fabrication of a CGM of an electrophotographic photoreceptor. The pigment powder is milled in a solvent for an extended period of time, typically for about 20 hours. In this case, the pigment powder may be milled in the presence of a binder resin. The milling process of the pigment powder is typically a ball milling process using glass beads, steel beads, zirconia beads, aluminum beads, zirconia balls, or steel balls in a ball mill, a sand mill, or a paint shaker, or a roll milling process using a roll mill such as a two-roll mill, a three-roll mill, or the like. In the milling process, the pigment powder is pulverized to a submicron level. A composition obtained in this way is called a CGM composition. Separately, an HTM, an ETM, and a binder resin are dissolved in a solvent to prepare a CTM composition. Then, the CGM composition and the CTM composition prepared separately are mixed to form a coating composition for producing a single layered photosensitive layer.

When a pigment powder is used as a CGM in the preparation of a coating composition for producing a conventional single layered photosensitive layer as described above, a milling process of the pigment powder is required, and a complicated process including separately preparing the CGM composition and the CTM composition and mixing them is required. However, the additional milling process of the CGM of the electrophotographic photoreceptors increases manufacturing costs and time

### SUMMARY OF THE INVENTION

The present invention provides an inexpensive method of making a coating composition to produce a single layered photosensitive layer.

According to an aspect of the present invention, a method of making a coating composition to produce a single layered photosensitive layer that includes a fine photosensitive pigment powder which may act as a charge generating material (CGM), dispersed in a binder resin solution includes: adding the pigment powder, a hole transporting material (HTM), an electron transporting material (ETM), and a binder resin to a solvent to wet the pigment powder; and homogenizing the components while finely pulverizing the pigment powder using a homogenizer.

In the coating composition to produce a single layered photosensitive layer, amounts of the used components may be 40-60 parts by weight of the binder resin, 1-7 parts by weight of the pigment powder, 10-40 parts by weight of the HTM, and 5-30 parts by weight of the ETM, based on 100 parts by weight of the solvent.

According to the method of making a coating composition to produce a single layered photosensitive layer, even when a pigment powder is used as a CGM, all components of the coating composition, including the pigment powder, are dispersed together in a solvent by a homogenizer without an additional milling process of the pigment powder, thus inexpensively obtaining the coating composition to produce a single layered photosensitive layer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of an embodiment of a method of producing a coating composition to yield a single layered photosensitive layer including a fine pigment powder, which acts as a charge generating material (CGM), dispersed in a solution of a binder resin in accordance with the present invention.

FIG. 2 is a block diagram of an embodiment of a photosensitive layer in accordance with the present invention.

### DETAILED DESCRIPTION OF THE PREFERRED EMBODIMENTS

A method of making a coating composition for producing a single layered photosensitive layer according to the present invention will now be described in more detail.

First, a pigment powder, a hole transporting material (HTM), an electron transporting material (ETM), and a binder resin are combined in a solvent to wet the pigment powder. For this, a container holding the mixture is shaken, for example, in a water bath for about 1-24 hours, and preferably 4-12 hours. By this operation, the pigment powder is wetted by the solvent, and the HTM, the ETM, and the binder resin are dissolved. When the shaking time is less than 1 hour, the pigment powder is insufficiently wet, so that the working efficiency of a subsequent dispersing process using a homogenizer may be reduced. When the shaking time is more than 24 hours, the effects of wetting the pigment powder does not increase further, and only the preparing time of the coating composition increases.

Subsequently, a homogenizer is used to homogenize the components while pulverizing the pigment powder to obtain a coating composition for producing a single layered photosensitive layer including a fine pigment powder capable of acting as a charge generating material (CGM).

Examples of the homogenizer used in the present invention include an ultrasonic homogenizer, a mechanical shear homogenizer, and the like.

Specific examples of the ultrasonic homogenizer include a model 150V/T and a model 300V/T available from BIOLOGICS INC., and a UPS 200S ultrasonic homogenizer available from ROSE SCIENTIFIC LTD. These ultrasonic homogenizers pulverize the pigment powder while homogenizing the composition through vibration generated by ultrasonic waves. Specific examples of the mechanical shear homogenizer include the T25 Homogenizer available from IKA, the Omni Mixer Homogenizer, the Omni Macro Homogenizer, the Omni Mixer-ES and the Omni Macro-ES Homogenizer available from OMNI INTERNATIONAL, and Potter S Homogenizer available from SARTORIUS AG. These mechanical shear homogenizers thoroughly mix the composition and finely pulverize the pigment powder using a rotor-stator generator probe.

A dispersing and homogenizing process using the homogenizer is performed for 0.5-4 hours, and preferably 1-2 hours. When the processing time is less than 0.5 hour, the pigment powder is insufficiently pulverized, which causes deterioration of the electrostatic property of an electrophotographic photoreceptor. Even if the processing time exceeds 4 hours, the effect of pulverizing the pigment powder does not increase further.

The amounts of the used components may be 40-60 parts by weight of the binder resin, 1-7 parts by weight of the pigment powder, 10-40 parts by weight of the HTM, and 5-30 parts by weight of the ETM, based on 100 parts by weight of the solvent.

When the amount of the binder resin is less than 40 parts by weight based on 100 parts by weight of the solvent, the coating composition may be released from an electrically conductive substrate after being coated due to insufficient binding force. When the amount of the binder resin is more than 60 parts by weight, the electrostatic property of an electrophotographic photoreceptor manufactured using the coating composition is reduced due to the reduction of the amounts of the CGM and a charge transporting material (CTM).

When the amount of the photosensitive pigment powder, which may act as a CGM, is less than 1 part by weight based on 100 parts by weight of the solvent, the amount of charge generated is insufficient, and when the amount of the photosensitive pigment powder is more than 7 parts by weight, the charging stability is reduced.

When the amount of the HTM is less than 10 parts by weight based on 100 parts by weight, the sensitivity is too low due to insufficient charge transporting ability, thereby increasing residual potential. When the amount of the HTM is more than 40 parts by weight, the amount of the binder resin in the photosensitive layer decreases, and thus, the mechanical strength is reduced.

When the amount of the ETM is less than 5 parts by weight based on 100 parts by weight of the solvent, the sensitivity is too low due to insufficient charge transporting ability, thereby increasing residual potential. When the amount of the ETM is more than 30 parts by weight, the amount of the binder resin in the photosensitive layer decreases, and thus, the mechanical strength is reduced.

Various organic solvents may be used to prepare the coating composition in the present invention. Examples of the organic solvents include alcohols, such as methanol, ethanol, isopropanol, butanol, and the like; aliphatic hydrocarbons, such as n-hexane, cyclohexane, heptane, and the like; aromatic hydrocarbons, such as benzene, toluene, xylene, and the like; halogenated hydrocarbons, such as dichloromethane, dichloroethane, trichloroethane, chloroform, carbon tetrachloride, chlorobenzene, and the like; ethers, such as dimethyl ether, diethyl ether, tetrahydrofurane, ethyleneglycoldimethyl ether, diethylenglycoldimethyl ether, and the like; ketones, such as acetone, methylethylketone, cyclohexanone, and the like; esters, such as ethyl acetate, methyl acetate, and the like; and dimethylformaldehyde, dimethylformamide, dimethylsulfoxide, and the like. These solvents are used alone or in a combination of two or more.

Examples of the binder resin used in the present invention include thermoplastic resins, such as styrene-butadiene copolymer, styrene-acrylonitrile copolymer, styrene-maleic acid copolymer, acrylic resin, methacrylic resin, styrene-acrylic acid copolymer, polyethylene, ethylene-vinyl acetate copolymer, chlorinated polyethylene, polyvinylacetate, polyvinylchloride, polyvinylidenechloride, polypropylene, ionomer, vinyl chloride-vinyl acetate copolymer, polyester, alkyd resin, polyamide, polyurethane, polycarbonate, polyacrylate, polystyrene, polysulfone, diallylphthalate resin, poly-N-vinylcarbazole, ketone resin, polyvinylformal, polyvinylbutyral resin, polyvinylacetal resin, penoxy resin, polyether resin, carboxymethyl cellulose, polyvinylalcohol, ethyl cellulose, and the like; and thermosetting resins, such as silicone resin, epoxy resin, phenolic resin, urea resin, melamine resin, silicone-alkyd resin, styrene-alkyd resin, and the like; and photocurable resins, such as epoxyacrylate, urethaneacrylate, and the like. These binder resins are used alone or in a combination of two or more.

Examples of the pigment powder used as the CGM in the photosensitive layer include CGMs conventionally known for an organophotoconductor, such as metal free phthalocyanine pigments, oxotitanylphthalocyanine pigments, hydroxygaliumphthalocyanine pigments, perylene pigments, bisazo pigments, bisbenzoimidazole pigments, metal free naphthalocyanine pigments, metal naphthalocyanine pigments, squarylium pigments, trisazo pigments, indigo pigments, azulenium pigments, quinone pigments, cyanine pigments, pyrylium pigments, anthraquinone pigments, triphenylmethane pigments, threne pigments, toluidine pigments, pyazoline pigments, or quinacridone pigment.

Metal free phthalocyanine pigments, oxotitanylphthalocyanine pigments, or hydroxygaliumphthalocyanine pigments are preferably used as the CGM in terms of light efficiency. The CGMs may be used alone or in a combination of two or more to have adsorption wavelength in a desired region.

The CTM used for a single layered electrophotographic photoreceptor of the present invention includes the conventionally known HTMs and ETMs.

Examples of the HTM include nitrogen containing cyclic compounds or condensed polycyclic compounds, such as enaminestylbene compounds, N,N,N′, N′-tetraphenylbenzidine compounds, N,N,N′, N′-tetraphenylphenylenediamine compounds, N,N,N′,N′-tetraphenylnaphthylenediamine compounds, N,N,N′,N′-tetraphenylphenanthrylenediamine compounds, oxadiazole compounds such as 2,5-di(4-methylaminophenyl)-1,3,4-oxadiazole, styryl compounds such as 9-(4-diethylaminostyrile)anthracene, carbazole compounds such as polyvinylcarbazole, organic polysilane compounds, pyrazoline compounds such as 1-phenyl-3-(p-dimethylaminophenyl) pyrazoline, hydrazone compounds, indole compounds, oxazole compounds, isoxazole compounds, thiazole compounds, thiadiazole compounds, imidazole compounds, pyrazole compounds, triazole compounds, and the like.

Enaminestylbene compounds may preferably be used as the HTM in terms of dispersion of the pigment. The HTM may be used alone or in a combination of two or more.

Examples of the ETM include electron attracting compounds such as naphthalenetetracarboxylic acid diimide compounds, diphenoquinone compounds, benzoquinone compounds, azoquinone compounds, monoquinone compounds, dinaphthylquinone compounds, carboxylic acid diimide compounds, stylbenequinone compounds, anthraquinone compounds, malononitrile compounds, thiopyrane compounds, xanthone compounds, trinitrothioxanthone compounds, fluorenone compounds, phenanthraquinone compounds, dinitroanthracene compounds, dinitroacridine compounds, nitroanthraquinone compounds, dinitroanthraquinone compounds, tetracyanoethylene compounds, cyanoquinodimethane compounds, dinitrobenzene compounds, anhydrous succinic acid compounds, anhydrous maleic acid compounds, anhydrous phthalic acid compounds, and halogenated anhydrous maleic acid compounds.

ETMs used in the present invention are not limited to materials listed herein, and electron transporting polymer compounds or other pigments having n-type semiconductor characteristic may also be used.

A naphthalenetetracarboxylic acid diimide compound having formula (1) below may preferably be used as the ETM since it has effective compatibility with the binder resin, such as polyester resin, polycarbonate resin, polyamide resin, or polyacrylate resin. Strong compatibility of the ETM with the binder resin prevents volume shrinkage in the vicinity of the ETM molecules during hot air drying when preparing a photosensitive layer from occurring and rarely forms a micropore on the surface of the photosensitive layer. On the contrary, the ineffective compatibility of the ETM with the binder resin causes volume shrinkage in the vicinity of the ETM molecules during hot air drying to occur readily and facilitates forming a micropore on the surface of the photosensitive layer.

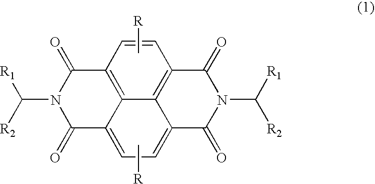

where R and R₁ are independently a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, or a C₇-C₃₀ substituted or unsubstituted aralkyl group;

R₂ is a group having the formula —(CH₂)ₙ—O—R₃;

R₃ is a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, or a C₇-C₃₀ substituted or unsubstituted aralkyl group; and

n is an integer between 1 and 12.

In the present invention, the ETMs may be used alone or in a combination of two or more.

The coating composition for a photosensitive layer, prepared using the simple and inexpensive method according to an embodiment of the present invention is coated on an electrically conductive substrate and dried to obtain a single layered electrophotographic photoreceptor.

A drum- or belt-shaped substrate including, for example, a metal or an electroconductive polymer, is used as the electrically conductive substrate. Examples of the metal include aluminum, stainless steel, and the like. Examples of the electroconductive polymer include polyester resin, polycarbonate resin, polyamide resin, polyimide resin, and a copolymer thereof in which an electroconductive material, such as electroconductive carbon, tin oxide, indium oxide, is dispersed.

Examples of the coating method include a dip coating, a ring coating, a roll coating, or a spray coating method. The thickness of the obtained single layered photosensitive layer is generally in the range of about 5-50 μm. When the single layered photosensitive layer is less than 5 μm thick, the sensitivity is insufficient, and when the single layered photosensitive layer is greater than 50 μm thick, the charging ability and the sensitivity are both reduced.

Meanwhile, in an embodiment of the method of making the coating composition of the present invention, a surfactant, a leveling agent, an antioxidant or a photo-stabilizing agent may be further included in the composition to improve the dispersion of the pigment, which is the CGM, and the CTM, ozone resistance and evenness of the photosensitive layer, and the like.

Meanwhile, in the preparation of the single layered photoreceptor, an electroconductive layer further may be formed between the electrically conductive substrate and the photosensitive layer. The electroconductive layer is obtained by dispersing an electroconductive powder, such as carbon black, graphite, metal powder or metal oxide powder in a solvent and then applying the resulting dispersion on the electrically conductive substrate and drying it. The thickness of the electroconductive layer may be in the range of about 5-50 μm.

Further, an intermediate layer may be interposed between the electrically conductive substrate and the electroconductive layer or between the electroconductive layer and the photosensitive layer to enhance adhesion or to prevent charges from being injected from the substrate. Examples of the intermediate layer include, but are not limited to, an aluminum anodized layer; a resin-dispersed layer of metal oxide powder, such as titanium oxide or tin oxide; and a resin layer such as polyvinyl alcohol, casein, ethylcellulose, gelatin, phenolic resin, or polyamide. The thickness of the intermediate layer may be in the range of 0.05- 5 μm.

Furthermore, in the preparation of the single layered photoreceptor, the photoreceptor may further include a surface protecting layer, if necessary.

The present invention will now be described in greater detail with reference to the following examples. The following examples are for illustrative purposes and are not intended to limit the scope of the invention.

### EXAMPLES

### Example 1

A solvent mixture of 280 g of dichloromethane and 120 g of 1,1,2-trichloroethane was placed in a container. Then, 3 g of x-type metal free phthalocyanine powder having formula (2) below, 17 g of an enaminestilbene-based HTM having formula (3) below, 20 g of naphthalenetetracarboxylic acid diimide compound having formula (4) as an ETM, and 60 g of a polyester binder resin (O-PET, available from KANEBO) having formula (5) were placed in the container, and then the container was sealed. The container was shaken at room temperature for about 1 hour to wet the metal free phthalocyanine powder with the solvent.

Thereafter, the mixture was dispersed by stirring with a 500 watt mechanical shear homogenizer (T25, available from IKA) at a rotation rate of about 11,000 rpm for about 1 hour. The obtained composition for producing a single layered photosensitive layer was measured using a laser scattering particle size distribution analyzer (LA-910, available form HORIBA, Japan). The average size of the dispersed particle in the composition was about 0.1 μm.

The obtained composition was coated on an anodized aluminum drum using a ring coater and dried at 110° C. for 1 hour to prepare an electrophotographic photoreceptor drum having a photosensitive layer with a thickness of about 15-16 μm.

### Comparative Example 1

90 g of 1,1,2-trichloroethane was placed in a container. Then, 5 g of O-PET binder resin was placed in the container and dissolved in the solvent. Thereafter, 3 g of x-type metal free phthalocyanine powder having formula (2) below was added to the solution, and the mixture was stirred. Subsequently, the mixture was milled with glass beads in a ball-mill machine (manufactured by KOREAN SCIENTIFIC INC. for 1 hour. The glass beads used for the milling were removed to obtain a charge generating layer (CGL) composition.

0.576 g of an enaminestilbene-based HTM having formula (3) below, 0.738 g of naphthalenetetracarboxylic acid diimide compound having formula (4) below, and 2.052 g of O-PET binder resin were placed in a 20 ml vial. Then, a solvent mixture of 10.08 g of dichloromethane and 1.8 g of 1,1,2-trichloroethane was added in the vial, and the mixture was dissolved in the solvent mixture to prepare a charge transporting layer (CTL) composition.

The CGL composition and the CTL composition were thoroughly mixed to obtain a coating composition for producing a single layered photosensitive layer.

The obtained composition for producing a single layered photosensitive layer was measured using a laser scattering particle size distribution analyzer (LA-910, available form HORIBA, Japan). The average size of the dispersed particle in the composition was about 0.1 μm.

The obtained composition was coated on an anodized aluminum drum using a ring coater and dried at 110° C. for 1 hour to prepare an electrophotographic photoreceptor drum having a photosensitive layer with a thickness of about 15-16 μm.

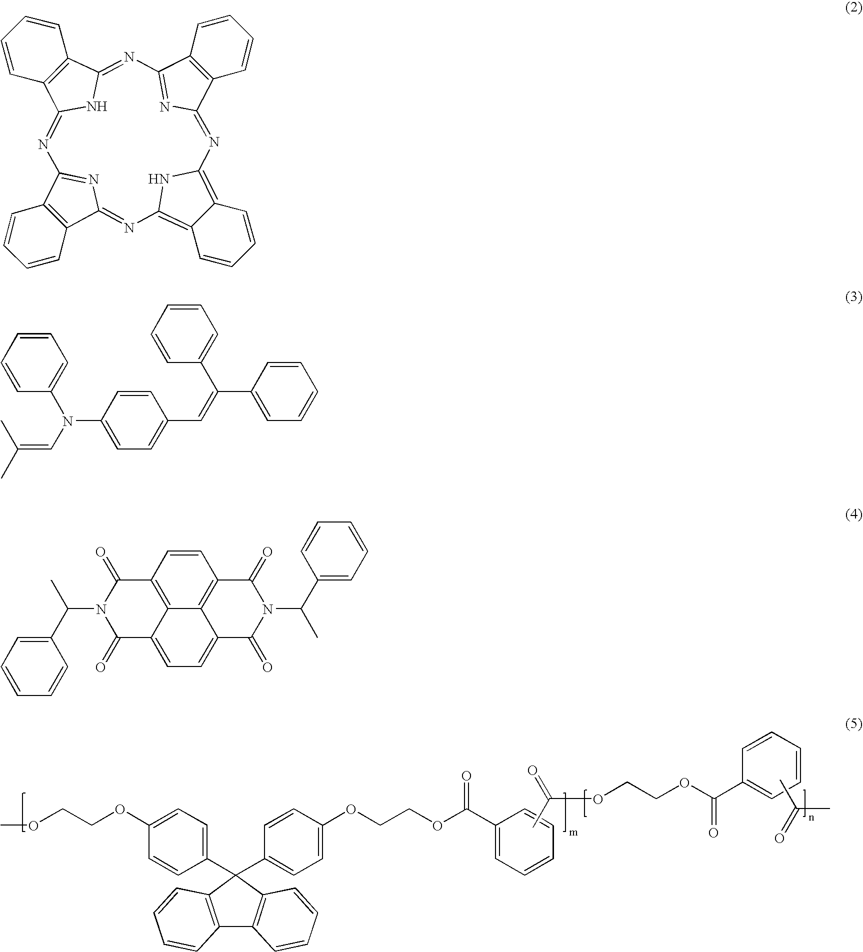

### Experimental Example

Electrostatic properties of the respective electrophotographic photoreceptors prepared in Example 1 and Comparative Example 1 were evaluated using a corona-charging type drum photoreceptor evaluation apparatus manufactured by SAMSUNG ELECTRONICS, INC. The diameter of the drum in the evaluation apparatus was 30 mm, the rotation rate of the drum was 5 ips (inch/second), and the exposure energy was 1.6 μJ/cm². The initial charge and exposure potentials and the charge and exposure potentials after printing 500 sheets of paper were measured. The evaluation results on the electrostatic properties are shown in Table 1.

TABLE 1

| | | | | | | Average size |
|---|---|---|---|---|---|---|
| | | | | | | of the |
| | Vo | Vd | | | | dispersed |
| | initial | initial | Vo 500 | Vd 500 | E_{1/2} | particle |
| | (V) | (V) | (V) | (V) | (μ J/cm²) | (μm) |
| Example 1 | 950 | 105 | 950 | 105 | 0.412 | 0.1 |
| Comparative | 945 | 105 | 950 | 105 | 0.411 | 0.1 |
| Example 1 | | | | | | |

Vo initial: initial charge potential
Vd initial: initial exposure potential
Vo 500: charge potential after printing 500 sheets of paper
Vd 500: exposure potential after printing 500 sheets of paper
E_{1/2}: Energy required to Vo initial decaying to a half value by exposure.

Referring to Table 1, the electrophotographic photoreceptor of Example 1 according to an embodiment of the present invention has similar electrostatic properties to the electrostatic properties of the electrophotographic photoreceptor of Comparative Example 1 which was manufactured in accordance with a conventional method. Thus, when using the method of making a coating composition for producing a single layered photosensitive layer according to an embodiment of the present invention, the preparation process of the coating composition is shortened, thereby saving manufacturing costs and time of the electrophotographic photoreceptor.

As described above, by using the method of making a coating composition for producing a single layered photosensitive layer according to an embodiment of the present invention, the preparation process of the coating composition is shortened, and thus, the manufacturing costs and time of an electrophotographic photoreceptor may be reduced.

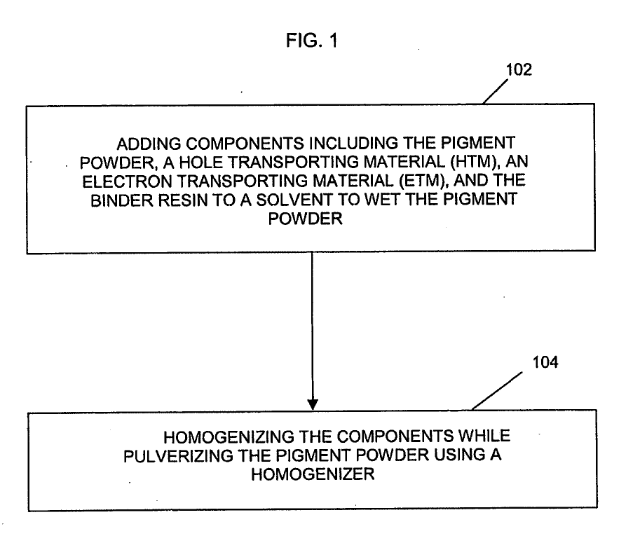

FIG. 1 shows an embodiment of the present invention, i.e., a method of producing a coating composition to yield a single layered photosensitive layer including a fine pigment powder, which acts as a charge generating material (CGM), dispersed in a solution of a binder resin. The method includes the steps of: (102) adding components including the pigment powder, a hole transporting material (HTM), an electron transporting material (ETM), and the binder resin to a solvent to wet the pigment powder; and (104) homogenizing the components while pulverizing the pigment powder using a homogenizer.

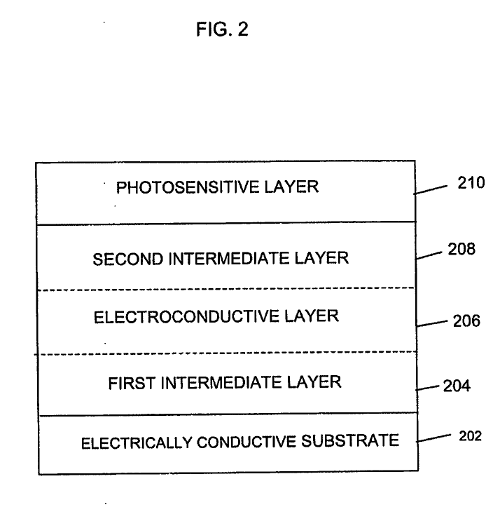

FIG. 2 is a block diagram of an embodiment of a photosensitive layer in accordance with the present invention. As shown in FIG. 2, a photosensitive layer, including a fine pigment powder, which is a charge generating material (CGM), dispersed in a solution of a binder resin, prepared by a process of: adding components including the fine pigment powder, a hole transporting material (HTM), an electron transporting material (ETM), and the binder resin to a solvent and shaking for a predetermined time to wet the pigment powder, the components being homogenized while pulverizing the pigment powder using the homogenizer to form a coating composition, wherein the coating composition is coated on an electrically conductive substrate 202 and dried to form the photosensitive layer 210. Where desired, an electroconductive layer 206 is further formed between the electrically conductive substrate 202 and the photosensitive layer 210. Where desired, a first intermediate layer 204 may be interposed between the electrically conductive substrate 202 and the electroconductive layer 206; or a second intermediate layer 208 may be interposed between the electroconductive layer 206 and the photosensitive layer 210.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of producing a coating composition to yield a single layered photosensitive layer including a pigment powder, which is a charge generating material (CGM), dispersed in a solution of a binder resin, the method comprising:
adding components including the pigment powder, a hole transporting material (HTM), an electron transporting material (ETM), and the binder resin to a solvent so as to wet the pigment powder; and
homogenizing the components while pulverizing the pigment powder.

2. The method of claim 1, further comprising an operation of shaking the components for a predetermined time to wet the pigment powder.

3. The method of claim 2, wherein the predetermined time is selected to be between 1-24 hours.

4. The method of claim 1, wherein the homogenizing operation occurs for a period of time between 0.05 to 4 hours.

5. The method of claim 1, wherein amounts of the components utilized are 40-60 parts by weight of the binder resin, 2-6 parts by weight of the pigment powder, 20-40 parts by weight of the HTM, and 5-30 parts by weight of the ETM, based on 100 parts by weight of the solvent.

6. The method of claim 1, wherein the homogenizing operation is performed by a mechanical shear homogenizer or an ultrasonic homogenizer.

7. The method of claim 1, wherein the pigment powder is selected from the group consisting of metal free phthalocyanine pigments, oxotitanylphthalocyanine pigments, hydroxygaliumphthalocyanine pigments, perylene pigments, bisazo pigments, bisbenzoimidazole pigments, metal free naphthalocyanine pigments, metal naphthalocyanine pigments, squarylium pigments, trisazo pigments, indigo pigments, azulenium pigments, quinone pigments, cyanine pigments, pyrylium pigments, anthraquinone pigments, triphenylmethane pigments, threne pigments, toluidine pigments, pyazoline pigments, quinacridone pigments, or a mixture thereof.

8. The method of claim 1, wherein the HTM is selected from the group consisting of enaminestylbene compounds, N,N,N′, N′-tetraphenylphenylenediamine compounds, N,N,N′,N′-tetraphenylnaphthylenediamine compounds, N,N,N′,N′-tetraphenylphenanthrylenediamine compounds, oxadiazole compounds, styryl compounds, carbazole compounds, organic polysilane compounds, pyrazoline compounds, hydrazone compounds, indole compounds, oxazole compounds, isoxazole compounds, thiazole compounds, thiadiazole compounds, imidazole compounds, pyrazole compounds, triazole compounds, or a mixture thereof.

9. The method of claim 1, wherein the ETM is selected from the group consisting of naphthalenetetracarboxylic acid diimide compounds, diphenoquinone compounds, benzoquinone compounds, azoquinone compounds, monoquinone compounds, dinaphthylquinone compounds, carboxylic acid diimide compounds, stylbenequinone compounds, anthraquinone compounds, malononitrile compounds, thiopyrane compounds, xanthone compounds, trinitrothioxanthone compounds, fluorenone compounds, phenanthraquinone compounds, dinitroanthracene compounds, dinitroacridine compounds, nitroanthraquinone compounds, dinitroanthraquinone compounds, tetracyanoethylene compounds, cyanoquinodimethane compounds, dinitrobenzene compounds, anhydrous succinic acid compounds, anhydrous maleic acid compounds, anhydrous phthalic acid compounds, and halogenated anhydrous maleic acid compounds, or a mixture thereof.

10. The method of claim 1, wherein the solvent is selected from the group consisting of alcohols, aliphatic hydrocarbons, aromatic hydrocarbons, halogenated hydrocarbons, ethers, ketones, esters, dimethylformaldehyde, dimethylformamide, and dimethylsulfoxide, or a mixture thereof.

11. The method of claim 1, wherein the binder resin is selected from the group consisting of styrene-butadiene copolymer, styrene-acrylonitrile copolymer, styrene-maleic acid copolymer, acrylic resin, methacrylic resin, styrene-acrylic acid copolymer, polyethylene, ethylene-vinyl acetate copolymer, chlorinated polyethylene, polyvinylacetate, polyvinylchloride, polyvinylidenechloride, polypropylene, ionomer, vinyl chloride-vinyl acetate copolymer, polyester, alkyd resin, polyamide, polyurethane, polycarbonate, polyacrylate, polystyrene, polysulfone, diallylphthalate resin, poly-N-vinylcarbazole, ketone resin, polyvinylformal, polyvinylbutyral resin, polyvinylacetal resin, penoxy resin, polyether resin, carboxymethyl cellulose, polyvinylalcohol, ethyl cellulose, silicone resin, epoxy resin, phenolic resin, urea resin, melamine resin, silicone-alkyd resin, styrene-alkyd resin, epoxyacrylate, and urethaneacrylate, or a combination of two or more of same.

12. The method of claim 1, wherein the ETM is selected from the group consisting of electron attracting compounds or electron transporting polymer compounds/pigments having n-type semiconductor characteristics.

13. The method of claim 1, wherein the ETM is a naphthalenetetracarboxylic acid diimide compound having formula (1) below: 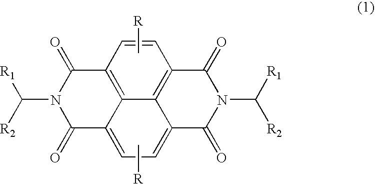
where R and R₁ are independently a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, or a C₇-C₃₀ substituted or unsubstituted aralkyl group;
R₂ is a group having the formula —(CH₂)ₙ—O—R₃;
R₃ is a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, or a C₇-C₃₀ substituted or unsubstituted aralkyl group; and
n is an integer between 1 and 12.

14. The method of claim 1, further comprising an additive added to the components, said additive being selected from the group consisting of a surfactant, a leveling agent, an anti-oxidant and a photo-stabilizing agent, or mixtures thereof.

15. An electrophotographic photoreceptor having a photosensitive layer including a pigment powder, which is a charge generating material (CGM), dispersed in a binder resin, the photosensitive layer being prepared by a process of:
adding components including the pigment powder, a hole transporting material (HTM), an electron transporting material (ETM), and the binder resin to a solvent to wet the pigment powder; and
homogenizing the components while pulverizing the pigment powder to form a coating composition,
wherein the coating composition is coated on an electrically conductive substrate and dried to form the photosensitive layer.

16. The photoreceptor of claim 15, further comprising an operation of shaking the components for a predetermined time to wet the pigment powder.

17. The photoreceptor of claim 16, wherein the predetermined time is selected to be between 1-24 hours.

18. The photoreceptor of claim 15, wherein the homogenizing operation occurs for a time period between 0.05 to 4 hours.

19. The electrophotographic photoreceptor of claim 15, wherein an electroconductive layer is further formed between the electrically conductive substrate and the photosensitive layer.

20. The electrophotographic photoreceptor of claim 19, wherein an intermediate layer is interposed between one of:
the electrically conductive substrate and the electroconductive layer; or
the electroconductive layer and the photosensitive layer.

21. The photoreceptor of claim 20, wherein the intermediate layer is selected from the group consisting of an aluminum anodized layer, a resin dispersed layer of metal-oxide powder, and a resin layer.

22. The photoreceptor of claim 21, wherein the metal oxide powder is selected from the group consisting of titanium oxide and tin oxide.

23. The photoreceptor of claim 21, wherein the resin layer is selected from the group consisting of polyvinyl alcohol, casein, ethyl-cellulose, gelatin, phenolic resin, and polyamide.
